(19) United States
(12) Patent Application Publication
(10) Pub. No.: US 2025/0015720 A1
(43) Pub. Date: Jan. 9, 2025

(54) CONTROL APPARATUS FOR DC-TO-DC CONVERTER AND PROGRAM

(71) Applicant: DENSO CORPORATION, Kariya-city (JP)

(72) Inventors: Kenji TOMITA, Nisshin-city (JP); Yasuaki AOKI, Kariya-city (JP); Yusuke UEDA, Kariya-city (JP); Takahiro SHIMIZU, Kariya-city (JP); Nobuyuki KITAMURA, Toyota-shi (JP)

(73) Assignee: DENSO CORPORATION, Kariya-city (JP)

(21) Appl. No.: 18/897,541

(22) Filed: Sep. 26, 2024

Related U.S. Application Data
(63) Continuation of application No. PCT/JP2023/007868, filed on Mar. 2, 2023.

(30) Foreign Application Priority Data
Mar. 31, 2022 (JP) 2022-060067

(51) Int. Cl. H02M 3/158

(52) U.S. Cl. CPC H02M 3/158

(57) ABSTRACT

A control apparatus for a DC-to-DC converter includes a switching controller working to selectively perform a first control task and a second control task. The first control task is to control on-off operations of switching devices of the DC-to-DC converter not to have at least one of an all-on period and an all-off period. The all-on period being a period of time in which all the switching devices are turned on. The all-off period is a period of time in which all the switching devices are turned off. The second control task is to control the on-off operations of the switching devices to have both the all-on period and the all-off period. The switching controller works to change the first control task to the second control task before a current mode is switched from a continuous current mode to a discontinuous current mode.

### CROSS REFERENCE TO RELATED DOCUMENT

The present application claims the benefit of priority of Japanese Patent Application No. 2022-060067 filed on Mar. 31, 2022, the disclosure of which is incorporated in its entirety herein by reference.

### TECHNICAL FIELD

This disclosure relates generally to a control apparatus for a DC-to-DC converter and a program.

### BACKGROUND ART

The international publication WO-A1-2020/095432 teaches a controller for a DC-to-DC converter equipped with a plurality of reactors. The reactors are magnetically coupled with each other through a core. The controller selectively works in an interleaving operation and an in-phase operation to control on-off operations of switching devices connecting with ends of the reactors. The interleaving operation is to drive the switching devices 180° out of phase with each other. The in-phase operation is to control the switching operations of the switching devices to be in phase with each other.

### PRIOR ART DOCUMENT

### Patent Literature

FIRST PATENT LITERATURE: International Publication WO-A1-2020/095432

### SUMMARY OF THE INVENTION

The above-described controller works to control a duty cycle of a drive signal outputted to each of the switching devices to bring an amount of electrical current flowing through a corresponding one of the reactors into agreement with a target value. There is, however, a risk that the controllability to use the duty cycle to control the amount of electrical current flowing through each of the reactors may be degraded in a discontinuous current mode during the interleaving operation.

It is an object of this disclosure to provide a control apparatus and a program for a DC-to-DC converter equipped with magnetic coupling reactors to improve controllability to control electrical currents flowing through the reactors.

According to one aspect of this disclosure, there is provided a control apparatus for a DC-to-DC converter which includes a plurality of reactors which are magnetically coupled with each other and switching devices each of which is connected to an end of a corresponding one of the reactors. The control apparatus comprises a switching controller which works to selectively perform a first control task and a second control task. The first control task is to control on-off operations of the switching devices not to have at least one of an all-on period and an all-off period. The all-on period is a period of time in which all the switching devices are turned on. The all-off period is a period of time in which all the switching devices are turned off. The second control task is to control the on-off operations of the switching devices to have both the all-on period and the all-off period. The switching controller works to change the first control task to the second control task before a current mode is switched from a continuous current mode to a discontinuous current mode.

When the continuous current mode is changed to the discontinuous current mode during execution of the first control task, the controllability to control the amount of electrical current flowing through reach of the reactors may be, as described below in detail, lowered.

When the discontinuous current mode has been entered during execution of the first control task, and electrical current is flowing through one of the reactors which connects with a corresponding one of the switching devices which is turned on, no electrical current may flow through the reactors connecting with the switching devices turned off. In this situation, switching of one of the switching devices to the off-state will result in a decrease in amount of electrical current flowing through the reactor connecting with the one of the switching devices changed to the off-state. Such a decrease causes a counterflow of electrical current to appear in the reactors through which no electrical current was flowing before because the reactors are magnetically coupled with each other. In such a case, it is impossible to increase or decrease the duty cycle for each of the switching devices to control the amount of electrical current flowing through a corresponding one of the reactors.

The control apparatus in this disclosure is, as described above, designed to change the first control task to the second control task before the current mode is switched from the continuous current mode to the discontinuous current mode. In the second control task, even when the discontinuous current mode is entered, counterflows of electrical current through the reactors are reduced more than in the first control task. The control apparatus in this disclosure is, therefore, capable of improving the controllability to control the amounts of electrical current flowing through the reactors.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is a structural view of a DC-to-DC converter according to the first embodiment;

FIGS. 2(A), 2(B), and 2(C) are views which demonstrate on-off states of switching devices and time-series changes in electrical current flowing through reactors in a first control task;

FIG. 3 is a graph which represents ranges where a continuous current mode and a discontinuous current mode are entered in a first control task;

FIG. 4 is a graph which represents a relation between a reactor current and a duty cycle when a continuous current mode is changed to a discontinuous current mode during execution of a first control task;

FIG. 5 is a flowchart of a program or a sequence of steps to execute a switching operation in the first embodiment;

FIGS. 6(A), 6(B), and 6(C) are views which show equivalent circuits of magnetically coupled reactors;

FIGS. 7(A), 7(B), and 7(C) are views which demonstrate time-series changes in reactor currents when a duty cycle is less than or equal to 0.5 and on-off states of switching devices in a first control task;

FIGS. 8(A), 8(B), and 8(C) are views which demonstrate time-series changes in reactor currents when a duty cycle is more than or equal to 0.5 and on-off states of switching devices in a first control task;

FIGS. 9(A), 9(B), and 9(C) are views which demonstrate time-series changes in reactor currents and on-off states of switching devices in a second control task;

FIG. 10 is a graph which represents an upper threshold value and a lower threshold value used in the first embodiment;

FIG. 11 is a view which demonstrates a relation between a first control task and a second control task in the first embodiment;

FIG. 12 is a graph which represents a relation of a reactor current and a duty cycle when a continuous current mode in a first control task is switched to a discontinuous current mode in a second control task;

FIGS. 13(A) and 13(B) are graphs which show degrees of followability of reactor currents;

FIGS. 14(A) and 14(B) are graphs each of which represents an upper threshold value and a lower threshold value in a first modification of the first embodiment;

FIG. 15 is a flowchart of a program or a sequence of steps to execute a switching operation in a second modification of the first embodiment;

FIG. 16 is a flowchart of a program or a sequence of steps to execute a switching operation in a third modification of the first embodiment;

FIG. 17 is a view which demonstrates how to switch between a first control task and a second control task in the second embodiment;

FIG. 18 is a graph which represents an upper threshold value and a lower threshold value in the second embodiment;

FIGS. 19(A), 19(B), and 19(C) are graphs which represent relations of an upper threshold value and a lower threshold value in modifications of the second embodiment;

FIG. 20 is a view which demonstrates how to switch between a first control task and a second control task in the 20 third embodiment;

FIGS. 21(A) and 20(B) are graphs which represent relations of an upper threshold value and a lower threshold value in the third embodiment;

FIG. 22 is a structural view of a DC-to-DC converter in another embodiment;

FIGS. 23(A), 23(B), and 23(C) are views which demonstrate sequences of on-off states of switching devices in a first control task in another embodiment; and

FIGS. 24(A) and 24(B) are views which demonstrate sequences of on-off states of switching devices in a second control task in another embodiment.

### MODE FOR CARRYING OUT THE INVENTION

### First Embodiment

A control apparatus according to the first embodiment will be described below with reference to the drawings. The control apparatus is implemented by the controller 40 which is installed in vehicle, such as a hybrid vehicle or an electrical vehicle, in which a traction motor is mounted and used for the DC-to-DC converter 20 (which will be simply referred to as converter 20).

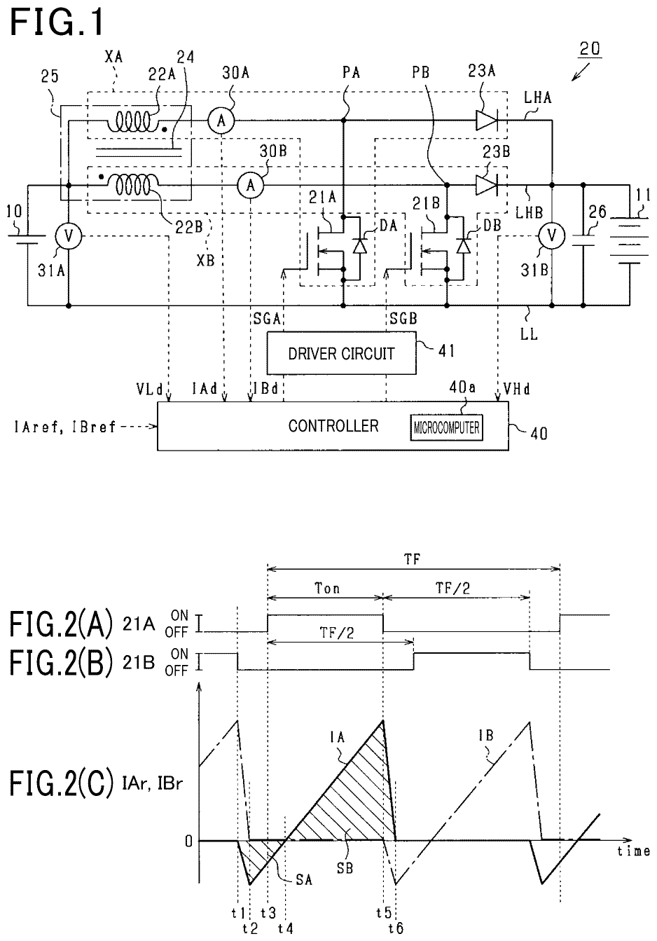

The converter 20, as illustrated in FIG. 1, includes an input unit connecting with the power supply 10 and an output unit connecting with the storage battery 11. The converter 20 works to step-up an input volage supplied from the input unit and output it from the output unit. The power supply 10 is implemented by, for example, a fuel cell which generates electricity using electrochemical reaction. The converter 20 includes a plurality of step-up circuits: the first step-up circuit XA and the second step-up circuit XB. The first step-up circuit XA and the second step-up circuit XB work as step-up chopper circuits. The first step-up circuit XA includes the first switching device 21A, the first reactor 22A, and the first diode 23A working as a rectifier. The first switching device 21A is made of an n-channel MOSFET.

The positive terminal of the power supply 10 and the positive terminal of the battery 11 are connected together using the first high-potential line LHA. The first switching device 21A has a drain connecting with the first high-potential line LHA. The power supply 10 has a negative terminal connecting with a negative terminal of the battery 11 using the low-potential line LL. The first switching device 21A has a source connecting with the low-potential line LL. The first switching device 21A has the body diode DA connecting in reverse-parallel thereto.

The first reactor 22A and the first diode 23A are arranged in the first high-potential line LHA. In the first high-potential line LHA, the first reactor 22A is located closer to the power supply 10 than a junction (which will also be referred below as the first junction PA) of the first reactor 22A and the first switching device 21A is. The first diode 23A is located closer to the battery 11 than the first junction PA is in the first high-potential line LHA. The first diode 23A is oriented to have an anode leading to the first junction PA and a cathode leading to the battery 11.

The second step-up circuit XB includes the second switching device 21B, the second reactor 22B, and the second diode 23B working as a rectifier. The second switching device 21B is made of an n-channel MOSFET. The power supply 10 has a positive terminal connecting with a positive terminal of the battery 11 using the second high-potential line LHB. The second switching device 21B has a drain connecting with the second high-potential line LHB. The second switching device 21B also has a source connecting with the low-potential line LL. The second switching device 21B, like the first switching device 21A, has the body diode DB connected in reverse parallel thereto.

The second reactor 22B and the second diode 23B are arranged in the second high-potential line LHB. In the second high-potential line LHB, the second reactor 22B is located closer to the power supply 10 than a junction (which will also be referred to as the second junction PB) of the second reactor 22B and the drain of the second switching device 21B is. The second diode 23B is located closer to the battery 11 than the second junction PB is in the second high-potential line LHB. The second diode 23B is oriented to have an anode leading to the second junction PB and a cathode leading to the battery 11.

The first reactor 22A and the second reactor 22B are magnetically coupled with each other. Specifically, the first reactor 22A and the second reactor 22B are wound around the core 24 so that they are inversely magnetically coupled to each other. More specifically, the first reactor 22A and the second reactor 22B are wound around the core 24 so that voltage appearing at one of ends of the first reactor 22A which leads to the first junction PA is higher than that at the other of the first reactor 22A leading to the power supply 10, voltage at one of ends of the second reactor 22B which leads to the power supply 10 may be higher than that at the other of the second reactor 22B leading to the second junction PB. In this embodiment, a ratio of the number of turns of the first reactor 22A to that of the second reactor 22B is set to one. The first reactor 22A, the second reactor 22B, and the core 24 constitute the magnetic coupling reactor 25.

The converter 20 includes the smoothing capacitor 26. The smoothing capacitor 26 is connected in parallel to the battery 11.

The converter 20 also includes the first current sensor 30A, the second current sensor 30B, the first voltage sensor 31A, and the second voltage sensor 31B. The first current sensor 30A measures a first reactor current IAr flowing through the first reactor 22A in the form of a first current IAd. The second current sensor 30B measures a second reactor current IBr flowing through the second reactor 22B in the form of a second current IBd. The first voltage sensor 31A measures voltage developed at the power supply 10 in the form of an input voltage VLd. The second voltage sensor 31B measures the output voltage VHd that is voltage outputted from the converter 20 to the battery 11. Outputs of the sensors 30A, 30B, 31A, and 31B are inputted to the controller installed in the converter 20.

The controller 40 includes the microcomputer 40a. The controller 40 is capable of performing functions realized by software stored in a memory device and a computer (i.e., the microcomputer 40a) executing the software or only by software, hardware, or a combination thereof. For instance, in a case where the controller 40 is provided by an electronic circuit (i.e., hardware), the electronic circuit may include a plurality of digital circuits (i.e., logic circuits) or analog circuits. For instance, the controller 40 is designed to execute a program shown in FIG. 5 which is stored in a non-transitory tangible storage medium that is a storage device installed therein to perform a predetermined task. The storage device installed in the controller 40 may be made of a non-volatile memory. The program retained in the storage device may be altered or updated using a communication network, such as the internet.

The controller 40 obtains measured parameters and perform control tasks using such parameters. Specifically, the controller 40 outputs the first gate signal SGA and the second gate signal SGB through the driver circuit 41 installed in the converter 20. The first gate signal SGA is a drive signal for driving the first switching device 21A. The second switching device 21B is a drive signal for driving the second switching device 21B. The controller 40 uses the first gate signal SGA and the second gate signal SGB to control switching operations of the first and second switching devices 21A and 21B.

The controller 40 selectively performs switching control tasks: a first control task and a second control task to control on-off states of the first switching device 21A and the second switching device 21B. The first control task is to turn on or off the first and second switching devices 21A and 21B in a first control mode where at least one of an all-on period and an all-off period does not appear. The all-on period is a period of time in which both the first and second switching devices 21A and 21B are simultaneously turned on. The all-off period is a period of time in which both the first and second switching devices 21A and 21B are simultaneously turned off.

Specifically, the first control task, as demonstrated in FIGS. 2(A) and 2(B), establishes a mode of operation of the controller 40 in which on-switching of each of the first and second switching devices 21A and 21B and off-switching of each of the first and second switching devices 21A and 21B both appear one time in the specified cycle TF, the on-switching of the second switching device 21B is shifted by TF/2 from that of the first switching device 21A, and the off-switching of the second switching device 21B is shifted by TF/2 from that of the first switching device 21A. This results in a 180° phase difference between the first reactor current IAr and the second reactor current IBr.

The second control task is to turn on or off the first and second switching devices 21A and 21B in a second control mode to have both the all-on period and the all-off period. Specifically, the second control task establishes a mode of operation of the controller 40 in which the on-switching of each of the first and second switching devices 21A and 21B and the off-switching of each of the first and second switching devices 21A and 21B both appear one time in the specified cycle TF, and the all-on period and the all-off period appear simultaneously. This results in phases of the first reactor current IAr and the second reactor current IBr being identical with each other.

In each of the first control task and the second control task, an electrical current-flow mode (which will be simply referred to below as a current mode) of each of the first and second reactor currents IAr and IBr is switched between a continuous current mode (CCM) and a discontinuous current mode (DCM). The continuous current mode is a current mode in which the on-off operation of each of the first and second switching devices 21A and 21B is controlled to hold a corresponding one of the first and second reactor currents IAr and IBr from having a value of zero. The discontinuous current mode is a current mode in which the on-off operation of each of the first and second switching devices 21A and 21B is controlled to establish a period of time in which each of the first and second reactor currents IAr and IBr temporarily have a value of zero. The execution of the discontinuous current mode, therefore, causes the electrical current to intermittently flow through the first and second reactors 22A and 22B.

The controller 40 is responsive to the first and second current command values IAref and IBref, as inputted form a main controller, to perform an average current control mode to control the on-off states of the first and second switching devices 21A and 21B. Specifically, the controller 40 analyzes the first and second currents IAd and IBd measured by the first and second current sensors 30A and 30B to calculate the first and second average values IAav and IBav that are time averages of levels of the first and second currents IAd and IBd in the specified cycle TF. In order to re-calculate the first and second current command values IAref and IBref using the first and second average values IAav and IBav in a feedback mode, the controller 40 calculates the duty cycle DT for each of the first and second switching devices 21A and 21B. The duty cycle DT, as referred to herein, is a ratio of an on-duration Ton of each of the first and second switching devices 21A and 21B to the specified cycle TF (i.e., Ton/TF). In this embodiment, the first current command value IAref and the second current command value IBref are determined to be identical with each other.

FIGS. 2(A) to 2(C) represent time-series changes in the first and second reactor currents IAr and IBr in the discontinuous current mode during execution of the first control task. In FIG. 2(C), a solid line indicates a change in the first reactor current IAr. A dash-dotted line indicates a change in the second reactor current IBr. Before time t1, the first switching device 21A is in the off-state, so that the first reactor current IAr is zero. The second switching device 21B is in the on-state, so that the second reactor current IBr gradually increases. When the second switching device 21B is switched to the off-state at time t1, it causes the second reactor current IBr to drop rapidly, which results in a change in magnetic flux in the core 24, thereby creating an electromotive force in the first reactor 22A which generates a flow of the first reactor current IAr from the battery 11 toward the power supply 10.

In the first high-potential line LHA in which the first reactor 22A is arranged, the first diode 23A is located closer to the battery 11 than the first reactor 22A is. This blocks a flow of electrical current from the battery 11 to the first reactor 22A. Generation of electromotive force in the first reactor 22A which serves to create a flow of the first reactor current IAr from the battery 11 toward the power supply 10 will, therefore, result in a flow of the first reactor current IAr from the body diode DA of the first switching device 21A toward the first reactor 22A. In other words, the first reactor current IAr flows backward.

The first reactor current IAr decreases for a period of time in which the second reactor current IBr decreases between times t1 and t2. When time t2 is reached, the first reactor current IAr starts to rise at a constant rate. At time t3, the first switching device 21A is switched to the on-state. When the first reactor current IAr flows backward at time t3, it causes electrical current to flow through the body diode DA in the forward direction, thereby resulting in insufficient voltage difference between the drain and source of the first switching device 21A. The slope of a change in the first reactor current IAr, therefore, remains unchanged even though the first switching device 21A is turned on. This causes the first reactor current IAr to rise slowly in the on-duration Ton of the first switching device 21A between times t3 and t5 at the same rate as that between times t2 and t3. Specifically, the first reactor current IAr reaches zero at time t4 and then becomes maximized at time t5. When the first switching device 21A is tuned off at time t5, the first reactor current IAr decreases rapidly and becomes zero at time t6.

In the above state, a total amount of the first reactor current IAr in the specified cycle TF is kept constant regardless of the duty cycle DT. Specifically, the sum of a total mount SA, as indicated by hatching in FIG. 2(C), of the first reactor current IAr flowing in the reverse direction between times t1 and t4 and a total amount SB of the first reactor current IAr flowing in the forward direction between times t4 and t6 is kept constant regardless of the duty cycle DT. This is because when the first switching device 21A is turned on while the first reactor current IAr is flowing in the reverse direction, the slope of a change in the first reactor current IAr between times t2 and t6, as apparent from Eq. (1) below, has a constant value given as a function the voltage VL at the power supply 10 and inductances Ls of the first and second reactors 22A and 22B.

$$\frac{dIAr}{dt} = \frac{VL}{Ls} \qquad Eq . ( 1 )$$

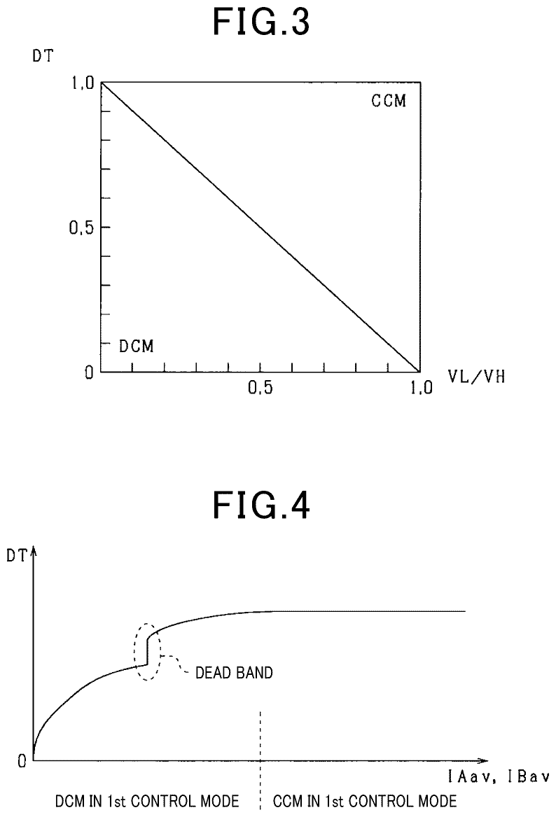

In the discontinuous current mode during execution of the first control task, each the first and second reactor currents IAr and IBr, as apparent from the above discussion, transiently flows in the reverse direction. This produces a head band in which each of the first and second average values IAav and IBav remains unchanged even though the duty cycle DT is increased or decreased in response to the backflow of the first and second average value IAav or IBav. FIG. 3 demonstrates ranges where the continuous current mode and the discontinuous current mode are entered in the first control tasks which are expressed using the duty cycle DT and an inverse step-up ratio VL/VH that is a reciprocal of a step-up ratio of the converter 20 where VH is voltage outputted to the battery 11. The first control task works to decrease the duty cycle DT with a decrease in each of the current command values IAref and IBref and change the current mode from the continuous current mode to the discontinuous current mode. The entry of the discontinuous current mode produces a dead band.

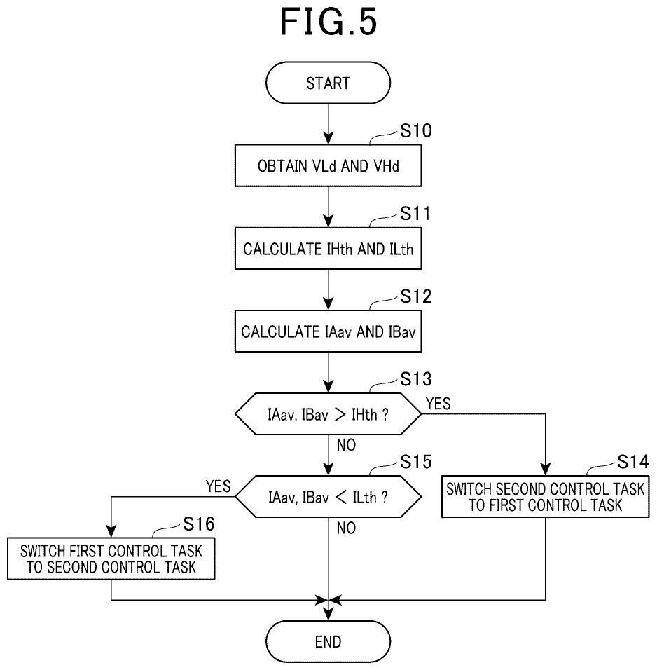

FIG. 4 represents a relation between each of the first and second average values IAav and IBav and the duty cycle DT when the continuous current mode is switched to the discontinuous current mode in the first control task. The occurrence of a dead band in the discontinuous current mode during execution of the first control task leads to a risk that the followability of the first and second average values IAav and IBav to the first and second current command values IAref and IBref may be deteriorated.

In order to alleviate the above drawback, when the current mode in the converter 20 is required to be switched from the continuous current mode to the discontinuous current mode in response to a decrease in the first reactor current IAr or the second reactor current IBr during execution of the first control task, the controller 40 works to change the first control task to the second control task before the discontinuous current mode is entered.

FIG. 5 illustrates a sequence of steps performed by the controller 40 to execute a switching operation. The switching operation is performed in a given cycle by the converter 20.

After entering the program of FIG. 5, the routine proceeds to step S10 wherein the input voltage VLd measured by the first voltage sensor 31A and the output voltage VHd measured by the second voltage sensor 31B are obtained. The routine proceeds to step S11 wherein the upper threshold value IHth and the lower threshold value ILth are calculated using the input voltage VLd and the output voltage VHd derived in step S10. The lower threshold value ILth is a reference value used to determine whether the current mode is required to be switched from the continuous current mode to the discontinuous current mode during execution of the first control task. The upper threshold value IHth is a reference value used to determine whether the current mode is required to be switched from the discontinuous current mode to the continuous current mode during execution of the first control task.

The routine proceeds to step S12 wherein the first and second average values IAav and IBav are calculated in the manner as described above. The routine proceeds to step S13 wherein it is determined whether the smaller of the first and second average values IAav and IBav calculated in step S12 is greater than the upper threshold value IHth. If a YES answer is obtained in step S13, then the routine proceeds to step S14 wherein when the second control task is currently being performed, it is switched to the first control task, while the first control task is now being performed, it is kept as it is. The operation in step S12 serves as an obtainer.

Alternatively, if a NO answer is obtained in step S13, then the routine proceeds to step 15 wherein the smaller of the first and second average values IAav and IBav is lower than the lower threshold value ILth. If a NO answer is obtained in step S15, the current switching control task (i.e., the first control task or the second control task) is kept as it is. Alternatively, if a YES answer is obtained in step S15, then the routine proceeds to step S16 wherein when the first control task is now being performed, it is switched to the second control task, while the second control task is now being performed, it is kept as it is. The operations in steps S13 and S15 serve as a determiner. The operations in steps S14 and S16 serve as a switching controller or will also be referred to as a switching operation in this disclosure.

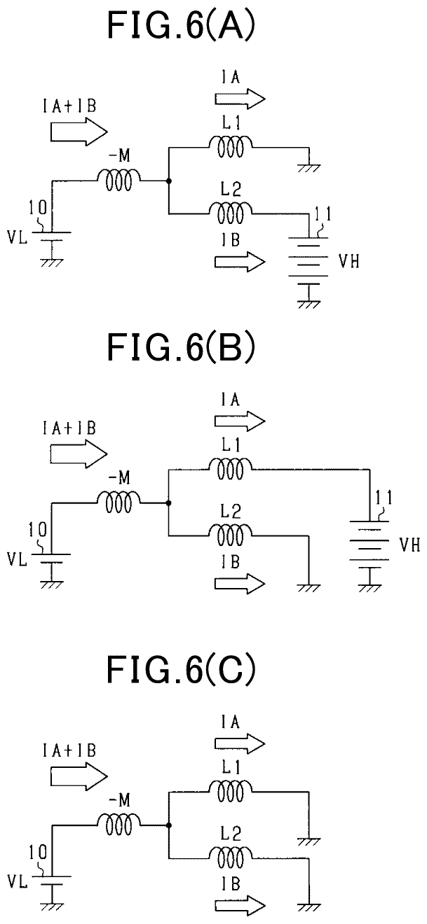

How to determine the upper threshold value IHth and the lower threshold value ILth will be described below with reference to FIGS. 6(A) to 10. First, the lower threshold value ILth will be referred to below. FIGS. 6(A) to 6(C) show an equivalent circuit of the magnetic coupling reactor 25.

Specifically, FIG. 6(A) illustrates the equivalent circuit when the first switching device 21A is turned on, while the second switching device 21B is turned off. FIG. 6(B) illustrates the equivalent circuit when the first switching device 21A is turned off, while the second switching device 21B is tuned on. FIG. 6(C) illustrates the equivalent circuit when the first and second switching devices 21A and 21B are both turned on. In the drawing, L1 indicates a self-inductance of the first reactor 22A. L2 indicates a self-inductance of the second reactor 22B. M indicates a mutual inductance of the first and second reactors 22A and 22B. The self-inductances L1 and L2 and the mutual inductance M are given using an inductance Ls and a coupling coefficient k according to Eqs. 2) and 3) below.

$$L 1 = L 2 = ( 1 + k ) \times Ls \qquad Eq . ( 2 )$$

$$M = k \times Ls \qquad Eq . ( 3 )$$

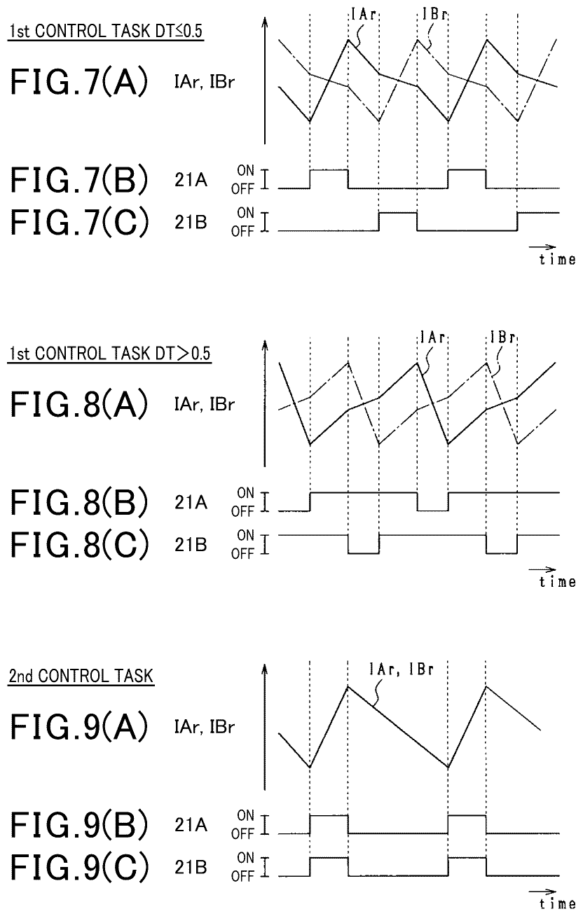

FIG. 7(A) demonstrates time-series changes in the first and second reactor currents IAr and IBr when the duty cycle DT is selected to meet a relation of DT≤0.5 in the first control task. A solid line represents a change in the first reactor current IAr. A dash dotted line represents a change in the second reactor current IBr. An equivalent circuit of the magnetic coupling reactor 25 in a period of time in which the first switching device 21A is turn on, while the second switching device 21B is turned off when the duty cycle DT≤0.5 is identical with that in FIG. 6(A). In this case, the following Eqs. (4) and (5) are met.

$$- M \frac{d ( IAr ) + d ( IBr )}{dt} + L 1 \frac{d ( IAr )}{dt} = VL \qquad Eq . ( 4 )$$

$$- M \frac{d ( IAr ) + d ( IBr )}{dt} + L 2 \frac{d ( IBr )}{dt} = VL - VH \qquad Eq . ( 5 )$$

A change in the first reactor current IAr is defined as ΔIA (=d(IA)). A change in the second reactor current IBr is defined as ΔIB(=d(IB)). Eqs. (4) and (5) are rewritten as Eqs. (6) and (7) below using a relation of DT×TF (=dt) in a period of time in which the first switching device 21A is turned on, and the second switching device 21B is turned off.

$$- M \frac{Δ IA + Δ IB}{DT \times TF} + L 1 \frac{Δ IA}{DT \times TF} = VL \qquad Eq . ( 6 )$$

$$- M \frac{Δ IA + Δ IB}{DT \times TF} + L 2 \frac{Δ IB}{DT \times TF} = VL - VH \qquad Eq . ( 7 )$$

A change ΔIA in the first reactor current IAr in a period of time in which the first switching device 21A is turned on, and the second switching device 21B is turned off is expressed by Eq. (9) using Eq. (8) shown below. Eq. (8) represents a relation among the inductance Ls of the first and second reactors 22A and 22B, a switching frequency f(=1/TF) and the duty cycle DT of the first and second switching devices 21A and 21B, the voltage VL at the power supply 10, and the volage VH outputted to the battery 11.

$$DT = \frac{VH - VL}{VH} \qquad Eq . ( 8 )$$

$$Δ IA = \frac{- 1}{VH \times f \times ( 1 - {κ}^{2} ) \times Ls} ( VH - VL ) \{ κ \times VH - ( 1 + κ ) \times VL \} \qquad Eq . ( 9 )$$

Half of the current change ΔIA represented by Eq. (9) is defined as a first reference value IX represented by Eq. (10) when the duty cycle DT meets a relation of of DT≤0.5. In the first control task, when the first average value IAav or the second average value IBav drops below the first reference value IX, the current mode is changed from the continuous current mode to the discontinuous current mode. In this embodiment, the first reference value IX when the duty cycle DT is lower than or equal to 0.5 is determined as the lower threshold value ILth used when the duty cycle DT is lower than or equal to 0.5.

$$IX = \frac{- 1}{2 \times VH \times f \times ( 1 - {κ}^{2} ) \times Ls} ( VH - VL ) \{ κ \times VH - ( 1 + κ ) \times VL \} \qquad Eq . ( 10 )$$

FIG. 8(A) represents changes in the first and second reactor currents IAr and IBr when the duty cycle DT meets a relation of DT>0.5 in the first control task. When the duty cycle DT greater than 0.5 demonstrated in FIGS. 8(A) to 8(C), an equivalent circuit of the magnetic coupling reactor 25 in a period of time in which the first switching device 21A is turn off, while the second switching device 21B is turned on is identical with that in FIG. 6(B). Eqs. (11) and (12) shown below are met which are expressed using a relation of (1−DT)×(TF(=dt)), the change ΔIA in the first reactor current IAr, and change ΔIA in the second reactor current IBr in a period of time in which the first switching device 21A is turned off, and the second switching device 21B is turned on.

$$- M \frac{Δ IA + Δ IB}{( 1 - DT ) \times TF} + L 1 \frac{Δ IA}{( 1 - DT ) \times TF} = VL - VH \qquad Eq . ( 11 )$$

$$- M \frac{Δ IA + Δ IB}{( 1 - DT ) \times TF} + L 2 \frac{Δ IB}{( 1 - DT ) \times TF} = VL \qquad Eq . ( 12 )$$

The change ΔIA in the first reactor current IAr in a period of time in which the first switching device 21A is turned off, and the second switching device 21B is turned off is expressed according to Eq. (13) below.

$$Δ IA = \frac{- VL}{VH \times f \times ( 1 - {κ}^{2} ) \times Ls} \{ VH - ( 1 + κ ) \times VL \} \qquad Eq . ( 13 )$$

Half of the current change ΔIA represented by Eq. (13) is defined as the first reference value IX represented by Eq. (14) when the duty cycle DT meets a relation of of DT>0.5. In the first control task, when the first average value IAav or the second average value IBav drops below the first reference value IX, the current mode is changed from the discontinuous current mode to the continuous current mode. In this embodiment, the first reference value IX when the duty cycle DT is greater than 0.5 is determined as the lower threshold value ILth used when the duty cycle DT is greater than 0.5.

$$IX = \frac{VL}{2 \times VH \times f \times ( 1 - {κ}^{2} ) \times Ls} \{ VH - ( 1 + κ ) \times VL \} \qquad Eq . ( 14 )$$

Next, the upper threshold value Ihth will be described below. FIG. 9(A) demonstrates changes in the first and second reactor currents IAr and IBr in the second control task. An equivalent circuit of the magnetic coupling reactor 25 in a period of time, as illustrated in FIGS. 9(B) and 9(C), in which the first switching device 21A is turn on, and the second switching device 21B is turned on is represented in FIG. 6(C). Eqs. (15) and (16) shown below are met which are expressed using a relation of (1−DT)×(TF(=dt)), the change ΔIA in the first reactor current IAr, and change ΔIA in the second reactor current IBr in a period of time in which the first switching device 21A is turned on, and the second switching device 21B is turned on.

$$- M \frac{Δ IA + Δ IB}{DT \times TF} + L 1 \frac{Δ IA}{DT \times TF} = VL \qquad Eq . ( 15 )$$

$$- M \frac{Δ IA + Δ IB}{DT \times TF} + L 2 \frac{Δ IB}{DT \times TF} = VL \qquad Eq . ( 16 )$$

The change ΔIA in the first reactor current IAr in a period of time in which the first switching device 21A is turned off, and the second switching device 21B is turned off is expressed by Eq. (17) below.

$$Δ IA = \frac{VL \times ( VH - VL )}{VH \times f \times ( 1 - κ ) \times Ls} \qquad Eq . ( 17 )$$

Half of the current change ΔIA represented by Eq. (17) is defined as the second reference value IY represented by Eq. (18). In the second control task, when the first average value IAav or the second average value IBav exceeds the second reference value IY, the current mode is changed from the discontinuous current mode to the continuous current mode. In this embodiment, the second reference value IY is determined as the upper threshold value IHth.

$$IY = \frac{VL \times ( VH - VL )}{2 \times VH \times f \times ( 1 - κ ) \times Ls} \qquad Eq . ( 18 )$$

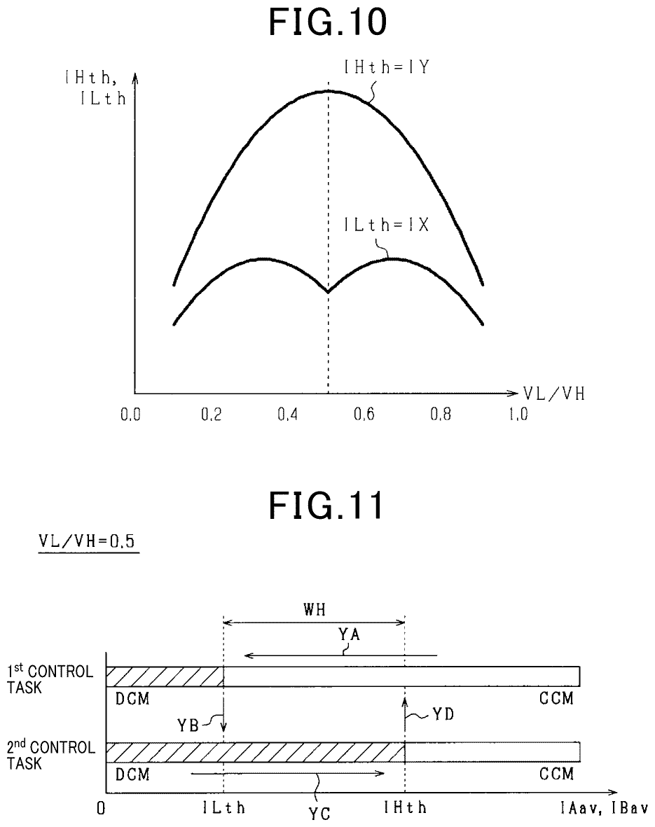

FIG. 10 demonstrates a relation of the upper threshold value IHth and the lower threshold value ILth to the inverse step-up ratio VL/VH. In a region where a relation of 0<VL/VH≤1.0 is met, the upper threshold value IHth is, as can be seen in FIG. 10, determined to be greater than the lower threshold value ILth. The upper threshold value IHth is maximized when a relation of VL/VH=0.5 is met and decreases with an increase in difference between the inverse step-up ratio VL/VH and 0.5. The inverse step-up ratio VL/VH has two values when the lower threshold value ILth is maximized when VL/VH≤0.5 and when the lower threshold value ILth is maximized when VL/VH>0.5. Specifically, when VL/VH≤0.5, the lower threshold value ILth becomes maximized near VL/VH=0.3 and decreases as it leaves VL/VH=0.3. When VL/VH>0.5, the lower threshold value ILth becomes maximized near VL/VH=0.7 and decreases as it leaves VL/VH=0.7.

How to switch between modes of on-off operations of the first and second switching devices 21A and 21B will be described below with reference to FIG. 11. FIG. 11 demonstrates a current range where the continuous current mode is entered in each of the first and second control tasks when a relation of VL/VH=0.5 is met and a current range where the discontinuous current mode is entered in each of the first and second control tasks when a relation of VL/VH=0.5 is met. When the first average value IAav or the second average value IBav is determined, as indicated by arrow YA, to drop below the lower threshold value ILth due to a decrease in the first or second reactor current IAr or IBr during execution of the first control task, the modes of on-off operations of the first and second switching devices 21A and 21B are, as indicated by an arrow YB, changed from the modes given by the first control task to those given by the second control task. This causes the current mode of the first and second reactor currents IAr and IBr to be switched to the discontinuous current mode in the second control task before the current mode is switched to the discontinuous current mode in the first control task. In the second control task, the on-off states of the first and second switching devices 21A and 21B are, as described above, controlled to have the first reactor current IAr and the second reactor current IBr identical in phase with each other. This holds the first and second reactor currents IAr and IBr from flowing in the reverse direction, thereby eliminating a risk that the dead band may occur.

When the first average value IAav or the second average value IBav is determined, as indicated by arrow YC, to rise above the upper threshold value IHth due to an increase in the first or second reactor current IAr or IBr during execution of the second control task, the modes of on-off operations of the first and second switching devices 21A and 21B are, as indicated by an arrow YD, changed from the modes given by the second control task to those given by the first control task. This causes the current mode of the first and second reactor currents IAr and IBr to be switched to the continuous current mode in the first control task before the current mode is switched to the continuous current mode in the second control task. In the continuous current mode in the second control task, a loss of operation of the converter 20 which arises from ripples of the first and second reactor currents IAr and IBr is usually greater than that in the continuous current mode in the first control task. In order to eliminate such a loss, the controller 40 works to prevent the continuous current mode from being entered in the second control task to alleviate the adverse effects of the ripples of the first and second reactor currents IAr and IBr.

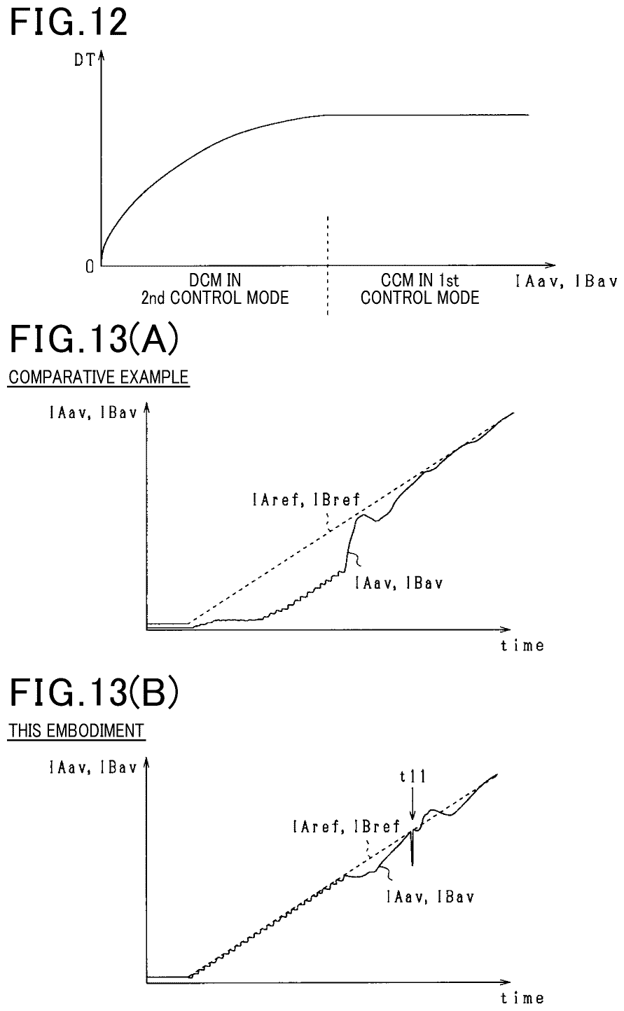

FIG. 12 represents a relation of the first and second average values IAav and IBav with the duty cycle DT when the continuous current mode in the first control task is changed to the discontinuous current mode in the second control task. A risk that the dead band may occur is, as can be seen in FIG. 12, eliminated in the discontinuous current mode in the second control task, thereby enhancing the accuracy in controlling the first and second average values IAav and IBav using the duty cycle DT.

FIGS. 13(A) and 13(B) demonstrate the followability of the first and second average values IAav and IBav in response to moderate changes in the first and second current command values IAref and IBref. FIG. 13(A) shows the followability of the first and second average values IAav and IBav in a comparative example wherein the continuous current mode in the first control task is changed to the discontinuous current mode in the first control task. In the comparative example in FIG. 13(A), the occurrence of the dead band results in a great deviation of the first and second average values IAav and IBav from the first and second current command values IAref and IBref.

In this embodiment illustrated in FIG. 13(B), the risk of occurrence of the dead band is eliminated, thus ensuring the stability in making the first and second average values IAav and IBav follow changes in the first and second current command values IAref and IBref. This enhances the controllability of electrical current in the average current control mode as compared with the comparative example. Time t11 in FIG. 13(A) is time when the second control task is changed to the first control task.

The above-described embodiment offers the following beneficial advantages.

In this embodiment, the lower threshold value ILth is, as can be seen in FIG. 10, determined to be lower than the second reference value IY. When the first or second reactor current IAr or IBr is, as demonstrated in FIG. 11, determined to have dropped below the lower threshold value ILth in the first control task, the controller 40 performs the switching operation to the discontinuous current mode in the second control task. The switching of the current mode after the second control task is entered to the discontinuous current mode, not the continuous current mode, as described above, minimizes a loss of operation of the converter 20 which arises from ripples of the first and second reactor currents IAr and IBr.

The switching operation in this embodiment is, as described already, to use the smaller of the first and second average values IAav and IBav to perform switch between the first control task and the second control task. Specifically, when the smaller of the first and second average values IAav and IBav is determined to have drop below the lower threshold value ILth, the first control task is changed to the second control task. This prevents the current mode of at least one of the first and second reactor currents IAr and IBr from being switched to the discontinuous current mode during execution of the first control task. Alternatively, when the smaller of the first and second average values IAav and IBav is determined to have exceeded the upper threshold value IHth, the second control task is changed to the first control task. This causes the second control task to continue to be performed until the current modes of both the first and second reactor currents IAr and IBr are switched to the continuous current mode during execution of the second control task. This reduces the number of switches between the first control task and the second control task, thereby controlling the deterioration of component parts, such as the first and second switching devices 21A and 21B, of the converter 20.

### First Modification of First Embodiment

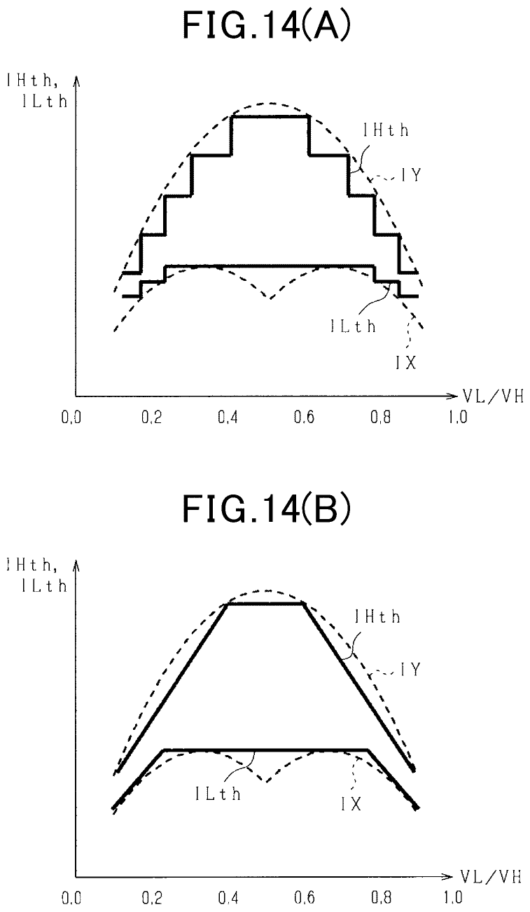

The controller 40 may determine the lower threshold value ILth to have a value intermediate between the first reference value IX and the second reference value IY instead of the first reference value IX. The controller 40 may also determine the upper threshold value IHth to have a value intermediate between the lower threshold value ILth and the second reference value IY. Specifically, the controller 40 may divide the range of 0<VL/VH≤1.0 into a plurality of sections shown in FIG. 14(A) and determine each of the upper threshold value IHth and the lower threshold value ILth to be constant in each of the sections. Alternatively, the controller 40 may divide the range of 0<VL/VH≤1.0 into a plurality of sections shown in FIG. 14(B) and determine each of the upper threshold value IHth and the lower threshold value ILth to change as a function of a change in the inverse step-up ratio VL/VH in some of the sections. In the example in FIG. 14(B), each of the upper threshold value IHth and the lower threshold value ILth is determined to change in proportional to a change in the inverse step-up ratio VL/VH in the rightmost and leftmost sections of the range. This facilitates the determination of the upper threshold value IHth and the lower threshold value ILth to reduce a load on operation of the controller 40.

### Second Modification of First Embodiment

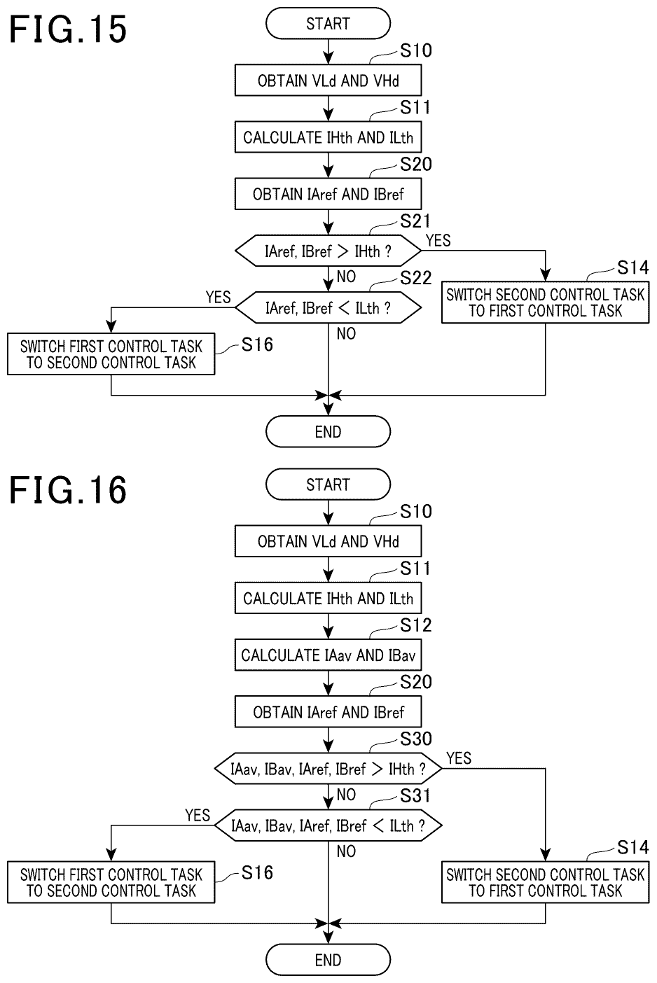

In the switching operation, the controller 40 may use the first and second current command values IAref and IBref instead of the first and second average values IAav and IBav to switch between the first control task and the second control task. FIG. 15 is a flowchart of a sequence of steps to perform the switching operation of the controller 40 in the second modification. The same step numbers as employed in FIG. 5 refer to the same operations, and explanation thereof in detail will be omitted here.

In the switching operation shown in FIG. 15, after the upper threshold value IHth and the lower threshold value ILth are determined in step S11, the routine proceeds to step S20 wherein the first and second current command values IAref and IBref are obtained. The operation in step S20 plays a role as an obtainer.

In step S21, it is determined whether the smaller of the first and second current command values IAref and IBref derived in step S20 is greater than the upper threshold value IHth. If a YES answer is obtained in step S21, then the routine proceeds to step S14. Alternatively, if a NO answer is obtained in step S21, then the routine proceeds to step S22 wherein the smaller of the first and second current command values IAref and IBref is lower than the lower threshold value ILth. If a NO answer is obtained, the switching operation currently performed is kept as it is. Alternatively, if a YES answer is obtained in step S22, then the routine proceeds to step S16 wherein the first control task is changed to the second control task in the same way as described above in FIG. 5. The use of the first and second current command values IAref and IBref instead of the first and second average values IAav and IBav eliminates the need for calculating the first and second average values IAav and IBav, thereby resulting in a decrease in load on the operation of the controller 40.

### Third Modification of First Embodiment

In the switching operation, the controller 40 may use the first and second current command values IAref and IBref in addition to the first and second average values IAav and IBav to switch between the first control task and the second control task. FIG. 16 is a flowchart of a sequence of steps to perform the switching operation of the controller 40 in the third modification. The same step numbers as employed in FIG. 5 refer to the same operations, and explanation thereof in detail will be omitted here.

In the switching operation shown in FIG. 16, after the first and second average values IAav and IBav are calculated in step S12, the routine proceeds to step S20 wherein the first and second current command values IAref and IBref are calculated. The operations in steps S12 and S20 play a role as an obtainer.

After step S20, the routine proceeds to step S30 wherein it is determined whether the smallest of the first and second average values IAav and IBav derived in step S12 and the first and second current command values IAref and IBref derived in step S20 is greater than the upper threshold value IHth. If a YES answer is obtained in step S30, then the routine proceeds to step S14. Alternatively, if a NO answer is obtained, then the routine proceeds to step S31 wherein it is determined whether the smallest of the first and second average values IAav and IBav and the first and second current command values IAref and IBref is lower than the lower threshold value ILth. If a NO answer is obtained in step S31, the switching operation currently performed is kept as it is. Alternatively, if a YES answer is obtained in step S31, then the routine proceeds to step S16 wherein the first control task is changed to the second control task in the same way as described above in FIG. 5.

### Second Embodiment

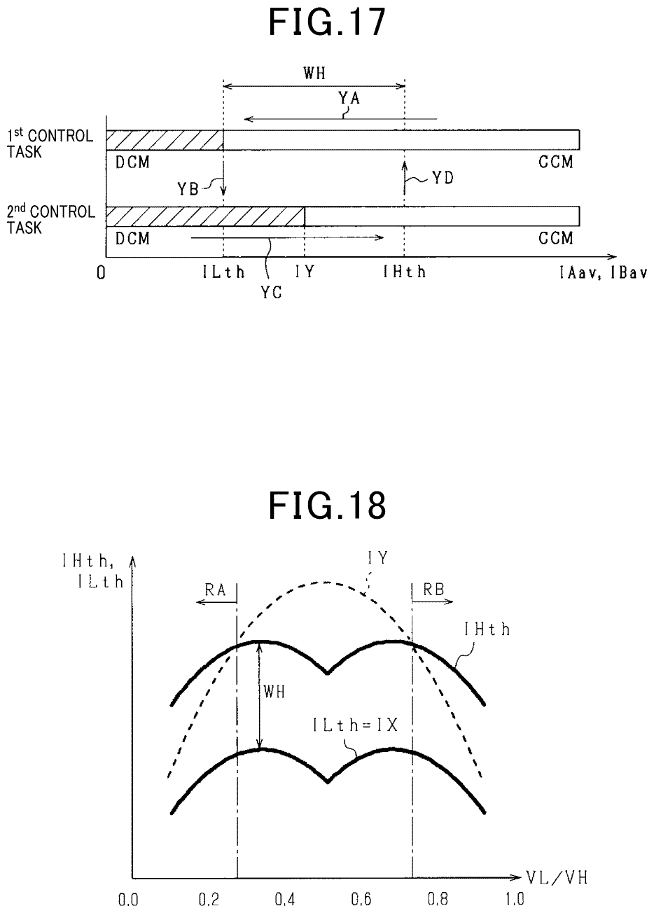

The second embodiment will be described below with reference to FIGS. 17 and 18 in terms of differences from the first embodiment. This embodiment is different from the first embodiment in how to determine the upper threshold value IHth.

FIG. 17 represents the first reference value IX and the second reference value IY when a difference between the first reference value IX and the second reference value IY decreases. Such an event is encountered, for example, when the inverse step-up ratio VL/VH becomes equal to 0.2 which is greatly different from 0.5.

In this embodiment, the upper threshold value IHth is determined to be higher than the second reference value IY. This causes, as can be seen in FIG. 17, the current mode to be switched from the discontinuous current mode to the continuous current mode in the second control task, after which the second control task is changed to the first control task. This causes a hysteresis range WH that is a difference between the upper threshold value IHth and the lower threshold value ILth to be widened more than when the upper threshold value IHth is set to the second reference value IY. This reduces the number of switches between the first control task and the second control task, thereby decreasing the deterioration of component parts, such as the first and second switching devices 21A and 21B, of the converter 20.

FIG. 18 represents a relation of the upper threshold value IHth and the lower threshold value ILth to the inverse step-up ratio VL/VH in this embodiment. The lower threshold value ILth is, like in the first embodiment, set to the first reference value IX, while the upper threshold value IHth is set to a value greater than the first reference value IX by the hysteresis range WH. The hysteresis range WH is determined to be a value which minimizes an increase in number of on-off operations of the first and second switching devices 21A and 21B. For example, the hysteresis range WH is set to an intermediate value in a range where a difference between the first reference value IX and the second reference value IY changes within a range of 0<VL/VH≤1.0. This causes the upper threshold value IHth to be greater than the first reference value IX in a portion(s) of the range of 0<VL/VH≤1.0. The hysteresis range WH, therefore, becomes greater than a difference between the first reference value IX and the second reference value IY in ranges RA and RB where the upper threshold value IHth is higher than the first reference value IX.

### Modifications of Second Embodiment

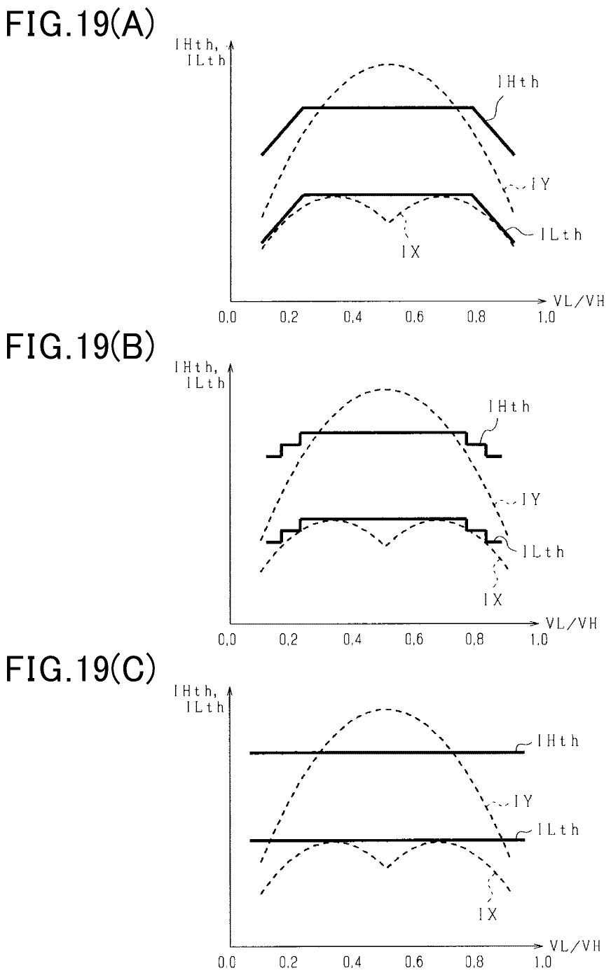

The controller 40 may determine the lower threshold value ILth to be a value intermediate between the first reference value IX and the second reference value IY. For instance, the controller 40, as demonstrated in FIG. 19(A), divides the range of 0<VL/VH≤1.0 into a plurality of sections and sets the upper threshold value IHth and the lower threshold value ILth to be constant in each of the sections. The controller 40 may alternatively, as illustrated in FIG. 19(B), divide the range of 0<VL/VH≤1.0 into a plurality of sections and determine the upper threshold value IHth and the lower threshold value ILth to change as a function of a change in the inverse step-up ratio VL/VH in one or more of the sections. The controller 40 may also determine the lower threshold value ILth to be greater than the second reference value IY in a portion(s) of the range of 0<VL/VH≤1.0. In this case, the controller 40 may, as illustrated in FIG. 19(C), determine the lower threshold value ILth to be constant in the range of 0<VL/VH≤1.0. This further facilitates how to determine the upper threshold value IHth and the lower threshold value ILth, thereby resulting in a decrease in load on the operation of the controller 40.

### Third Embodiment

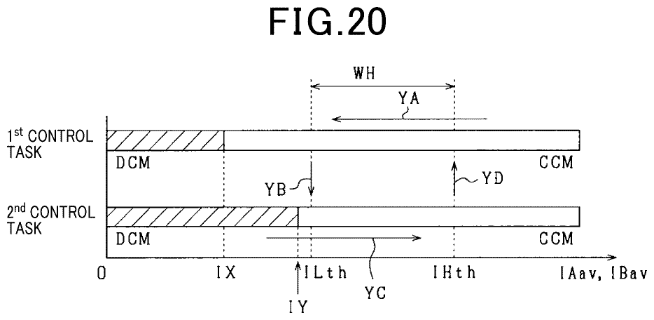

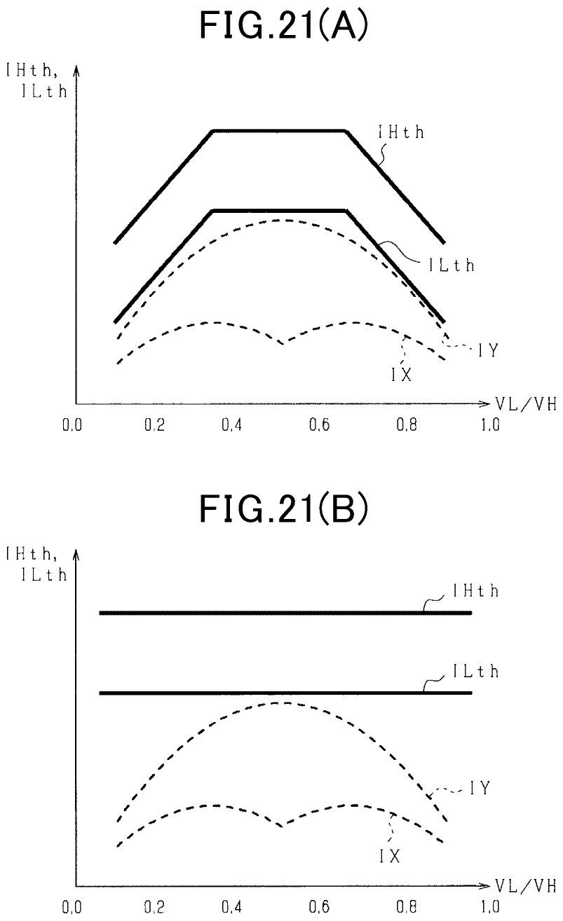

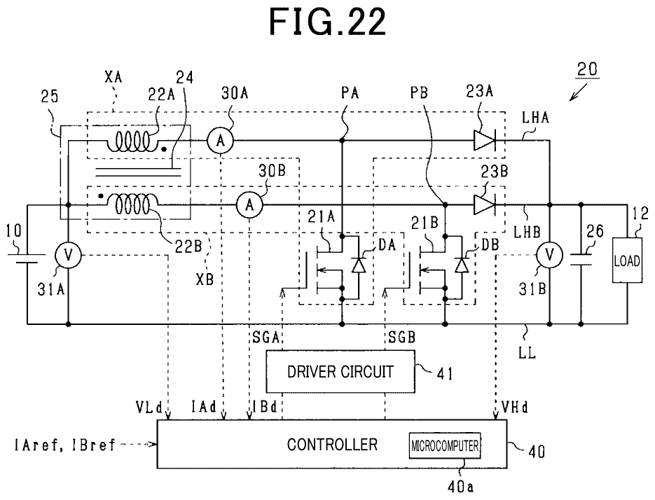

The third embodiment will be described below with reference to FIGS. 20 to 21(B) in terms of differences from the second embodiment. This embodiment is different from the second embodiment in how to determine the lower threshold value ILth.

FIG. 20 represents the upper threshold value IHth and the lower threshold value ILth determined in this embodiment. The lower threshold value ILth is determined to be greater than the second reference value IY. A decrease in the first or second reactor current IAr or IBr during execution of the first control task, therefore, causes, as illustrated in FIG. 20, the first control task to be switched to the second control task in which the continuous current mode is entered, thereby minimizing a change in current mode which arises from switch from the first control task to the second control task.

When the current mode of the first and second reactor currents IAr and IBr is changed between the continuous current mode and the discontinuous current mode, it causes overcurrent to temporarily appear in the first and second reactor currents IAr and IBr due to a difference in how to calculate the first and second average values IAav and IBav between the continuous current mode and the discontinuous current mode. An increase in number of switches between the continuous current mode and the discontinuous current mode, therefore, results in a drawback that accelerates the deterioration of component parts, such as the first and second switching devices 21A and 21B, of the converter 20. This embodiment, as apparent from the above discussion, works to decrease the number of changes in the current mode when the first control task is switched to the second control task, thereby minimizing the deterioration of component parts of the converter 20.

FIGS. 21(A) and 21(B) represent relations of the upper threshold value IHth and the lower threshold value ILth to the inverse step-up ratio VL/VH in this embodiment. The lower threshold value ILth is set to be greater than the second reference value IY. The upper threshold value IHth is, like in the second embodiment, set to be greater than the first reference value IX by the range threshold Wth. The controller may, as illustrated in FIG. 21(A), divide the range of 0<VL/VH≤1.0 into a plurality of sections and determine each of the upper threshold value IHth and the lower threshold value ILth to be constant in each of the sections. Alternatively, the controller 40 may, as illustrated in FIG. 21(B), determine the upper threshold value IHth and the lower threshold value ILth to be constant in the range of 0<VL/VH≤1.0.

### Other Embodiments

Each of the above embodiment may be modified in the following ways.

Electrical power generated by the converter 20 may be, as illustrated in FIG. 12, supplied to the electrical load 12 instead of the battery 11.

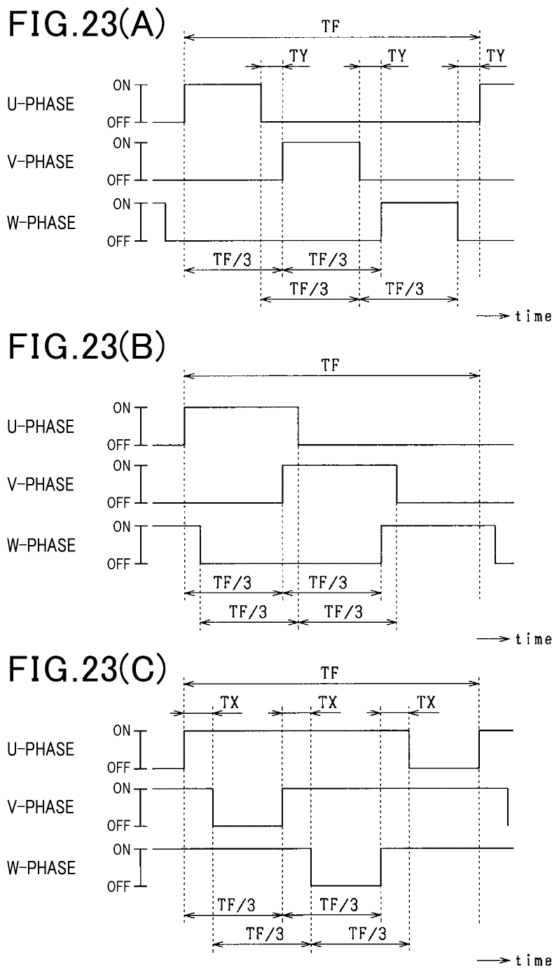

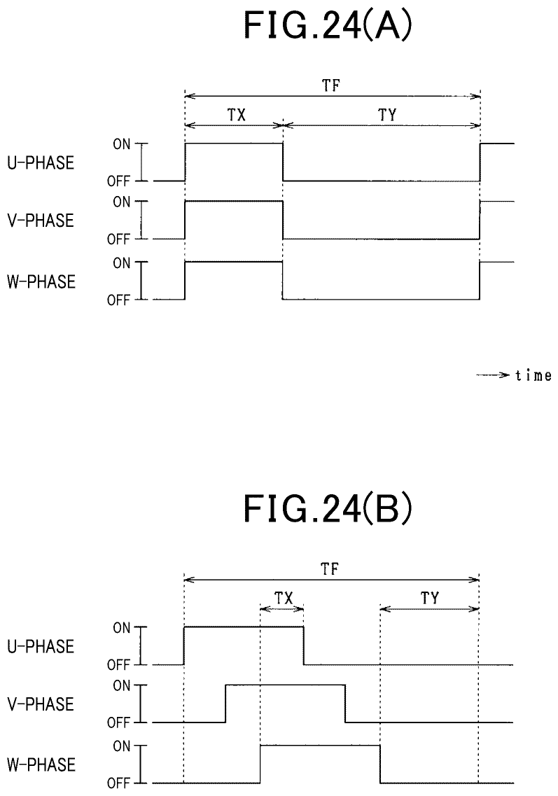

The converter 20 may be designed to have three or more step-up circuits. FIGS. 23(A) to 24(B) demonstrate a case where the converter 20 includes three step-up circuits: a U-phase circuit, a V-phase circuit, and a W-phase circuit each of which is equipped with a switching device.

FIGS. 23(A) to 23(C) demonstrate time-series changes in operation of the switching devices during execution of the first control task. FIGS. 23(A) to 23(C) are different in the duty cycle DT from each other. The duty cycle DT is higher from FIG. 23(A) to FIG. 23(C). In each example, each of the U-phase, V-phase, and W-phase switching devices is placed in the on-state and then in the off-state each of which appears one time in the specified cycle TF. Times when the U-phase, V-phase, and W-phase switching devices are turned on are shifted from each other by TF/3. Similarly, times when the U-phase, V-phase, and W-phase switching devices are turned off are shifted from each other by TF/3. This causes a phase difference between two of the U-phase, V-phase, and W-phase switching devices to be 120°.

An all-on period in which all the U-phase, V-phase, and W-phase switching devices are turned on is defined as TX. An all-off period in which all the U-phase, V-phase, and W-phase switching devices are turned off is defined as TY. In the example of FIG. 23(A), there is only the all-off period TY. In the example of FIG. 23(B), there is neither the all-on period TX nor the all-off period TY. In the example of FIG. 23(C), there is only the all-on period TX. The controller 40 is, therefore, capable of controlling the on-off states of the U-phase, V-phase, and W-phase switching devices without at least one of the all-on period TX and the all-off period TY by controlling the duty cycle DT in the first control task.

FIGS. 24(A) and 24(B) show changes in operation of the U-phase, V-phase, and W-phase switching devices in the second control task. FIG. 24(A) represents changes in on-off operation of the U-phase, V-phase, and W-phase switching devices which are driven synchronously with each other. FIG. 24(B) represents changes in on-off operation of the U-phase, V-phase, and W-phase switching devices which are driven substantially synchronously with each other with small phase differences therebetween. In either example, each of the U-phase, V-phase, and W-phase switching devices is placed in the on-state and then in the off-state each of which appears one time in the specified cycle TF. There are both the all-on period TX and the all-off period TY in the second control task. The controller 40 is, therefore, capable of turning on or off the U-phase, V-phase, and W-phase switching devices to have both the all-on period TX and the all-off period TY in the second control task.

The converter 20 may alternatively designed to have switching devices working to perform synchronous rectification instead of the first and second diodes 23A and 23B.

The power supply 10 may alternatively be implemented by a charge and discharge secondary battery, such as a lithium-ion storage battery.

The converter 20 may be installed in a mobile object, such as a ship or an airplane instead of an automotive vehicle. The converter 20 may also be used with a stationary device, such as a manufacturing machine installed in a factory.

The controllers or how to construct them referred to in this disclosure may be realized by a special purpose computer which is equipped with a processor and a memory and programmed to execute one or a plurality of tasks created by computer-executed programs or alternatively established by a special purpose computer equipped with a processor made of one or a plurality of hardware logical circuits. The controllers or operations thereof referred to in this disclosure may alternatively be realized by a combination of an assembly of a processor with a memory which is programmed to perform one or a plurality of tasks and a processor made of one or a plurality of hardware logical circuits. Computer-executed programs may be stored as computer executed instructions in a non-transitory computer readable medium.

This disclosure is not limited to the above embodiments, but may be realized by various embodiments without departing from the purpose of the disclosure. This disclosure includes all possible combinations of the features of the above embodiments or features similar to the parts of the above embodiments. The structures in this disclosure may include only one or some of the features discussed in the above embodiments unless otherwise inconsistent with the aspects of this disclosure.

The above embodiments realize the following unique structures.

### First Structure

A control apparatus (40) is used for a DC-to-DC converter (20) which includes a plurality of reactors (22A, 22B) which are magnetically coupled with each other and switching devices (21A, 21B) each of which is connected to an end of a corresponding one of the reactors. The control apparatus comprises a switching controller which works to selectively perform a first control task and a second control task. The first control task is to control on-off states of the switching devices not to have at least one of an all-on period and an all-off period. The all-on period is a period of time in which all the switching devices are turned on. The all-off period is a period of time in which all the switching devices are turned off. The second control task is to control the on-off states of the switching devices to have both the all-on period and the all-off period. The switching controller works to change the first control task to the second control task before a current mode is switched from a continuous current mode to a discontinuous current mode.

### Second Structure

The control apparatus, as set forth in the first structure, further comprises a determiner which determines whether the current mode is required to switch from the continuous current mode to the discontinuous current mode during execution of the first control task. When it is determined by the determiner that the current mode is required to change to the discontinuous current mode, the switching controller changes the first control task to the second control task in which the discontinuous current mode is entered.

### Third Structure

The control apparatus, as set forth in the second structure, wherein the determiner determines whether the current mode is required to change from the discontinuous current mode to the continuous current mode during execution of the second control task. When it is determined by the determiner that the current mode is required to change to the discontinuous current mode, the switching controller changes the second control task to the first control task in which the continuous current mode is entered.

### Fourth Structure

The control apparatus, as set forth in the third structure, wherein when a time average of electrical current flowing through one of the reactors during execution of the first control task has dropped below a lower threshold value (ILth) during execution of the first control task, the determiner determines that the current mode is required to change from the continuous current mode to the discontinuous current mode. When a time average of electrical current flowing through one of the reactors during execution of the second control task has exceeded an upper threshold value (IHth), the determiner determines that the current mode is required to change from the discontinuous current mode to the continuous current mode.

### Fifth Structure

The control apparatus, as set forth in the second structure, wherein when it is determined that after the current mode is changed from the discontinuous current mode to the continuous current mode, a time average of electrical current flowing through one of the reactors has exceeded a threshold value (IHth) during execution of the second control task, the switching controller changes the second control task to the first control task in which the current mode is switched to the continuous current mode.

### Sixth Structure

The control apparatus, as set forth in the first structure, further comprises a determiner which works to determine whether the current mode is required to change from the continuous current mode to the discontinuous current mode during execution of the first control task. When it is determined by the determiner that the current mode is required to be changed to the discontinuous current mode, the switching controller changes the first control task to the second control task in which the current mode is changed to the continuous current mode.

### Seventh Structure

The control apparatus, as set forth in the sixth structure, wherein when a time average of electrical current flowing through one of the reactors during execution of the first control task has dropped below a lower threshold value (ILth) during execution of the first control task, the determiner determines that the current mode is required to change from the continuous current mode to the discontinuous current mode. When it is determined that a time average of electrical current flowing through one of the reactors during execution of the second control task has exceeded an upper threshold value (IHth) that is set greater than the lower threshold value, the switching controller changes the second control task to the first control task in which the current mode is switched to the continuous current mode.

### Eighth Structure

The control apparatus as set forth in any one of the first, fifth, and seventh structures, wherein the time average of electrical current flowing through one of the reactors is a smallest one of time averages of electrical currents flowing through the reactors and command values used to create the time averages of electrical currents flowing through the reactors.

### Ninth Structure

The control apparatus as set forth in any one of the first to seventh structure, wherein each of the reactors has a first end connecting with an input unit. Each of the switching devices connects with a second end of a corresponding one of the reactors. The DC-to-DC converter includes rectifiers (23A, 23B) provided one for each of the reactors. Each of the rectifiers connects between an output unit and the second end of a corresponding one of the reactors. Each of the rectifiers works to allow electrical current to flow from a corresponding one of the reactors to the output unit and block a flow of electrical current from the output unit to the one of the reactors.

### Tenth Structure

The control apparatus as set forth in the ninth structure, wherein each of the switching devices is made of a semiconductor switching device equipped with a body diode (DA, DB).

### Eleventh Structure

The control apparatus as set forth in the ninth or tenth structure, wherein the DC-to-DC converter includes the N reactors where N is an integer more than or equal to two. The first control task is to control on-off states of the switching devices to place each of the switching devices in an on-state and then in an off-state each of which appears one time in a specified cycle (TF). Times when the switching devices are placed in the on-state are shifted by the specified cycle/N from each other. Times when the switching devices are placed in the off-state are shifted by the specified cycle/N from each other. The second control task is to control the on-off states of the switching devices to place each of the switching devices in the on-state and then in the off-state each of which appears one time in the specified cycle (TF) and to have both the all-on period and the all-off period.

### Twelfth Structure

A program for used with a DC-to-DC converter (20) which includes a plurality of reactors (22A, 22B), switching devices (21A, 21B) provided one for each of the reactors, and a computer (40a). The reactors are magnetically coupled with each other. Each of the switching devices is connected to an end of a corresponding one of the reactors. The program is executed by the computer to perform a switching operation on the switching devices in a selected one of a first control task and a second control task. The first control task is to control on-off states of the switching devices not to have at least one of an all-on period and an all-off period. The all-on period is a period of time in which all the switching devices are turned on. The all-off period is a period of time in which all the switching devices are turned off. The second control task is to control the on-off states of the switching devices to have both the all-on period and the all-off period. The switching operation is to change the first control task to the second control task before a current mode is switched from a continuous current mode to a discontinuous current mode.

1.-12. (canceled)

13. A control apparatus for a DC-to-DC converter which includes a plurality of reactors which are magnetically coupled with each other and switching devices each of which is connected to an end of a corresponding one of the reactors, comprising:
a switching controller which works to selectively perform a first control task and a second control task, wherein
the first control task is to control on-off operations of the switching devices not to have at least one of an all-on period and an all-off period, the all-on period being a period of time in which all the switching devices are turned on, the all-off period being a period of time in which all the switching devices are turned off,
the second control task is to control the on-off operations of the switching devices to have both the all-on period and the all-off period,
the switching controller works to change the first control task to the second control task before a current mode is switched from a continuous current mode to a discontinuous current mode.

14. The control apparatus as set forth in claim 13, further comprising a determiner which determines whether the current mode is required to switch from the continuous current mode to the discontinuous current mode during execution of the first control task, and wherein
when it is determined by the determiner that the current mode is required to change to the discontinuous current mode, the switching controller changes the first control task to the second control task in which the discontinuous current mode is entered.

15. The control apparatus as set forth in claim 14, wherein the determiner determines whether the current mode is required to change from the discontinuous current mode to the continuous current mode during execution of the second control task, and
when it is determined by the determiner that the current mode is required to change to the discontinuous current mode, the switching controller changes the second control task to the first control task in which the continuous current mode is entered.

16. The control apparatus as set forth in claim 15, wherein when a time average of electrical current flowing through one of the reactors during execution of the first control task has dropped below a lower threshold value during execution of the first control task, the determiner determines that the current mode is required to change from the continuous current mode to the discontinuous current mode, and wherein
when a time average of electrical current flowing through one of the reactors during execution of the second control task has exceeded an upper threshold value, the determiner determines that the current mode is required to change from the discontinuous current mode to the continuous current mode.

17. The control apparatus as set forth in claim 14, wherein when it is determined that after the current mode is changed from the discontinuous current mode to the continuous current mode, a time average of electrical current flowing through one of the reactors has exceeded a threshold value during execution of the second control task, the switching controller changes the second control task to the first control task in which the current mode is switched to the continuous current mode.

18. The control apparatus as set forth in claim 13, further comprising a determiner which works to determine whether the current mode is required to change from the continuous current mode to the discontinuous current mode during execution of the first control task, and wherein
when it is determined by the determiner that the current mode is required to be changed to the discontinuous current mode, the switching controller changes the first control task to the second control task in which the current mode is changed to the continuous current mode.

19. The control apparatus as set forth in claim 18, wherein when a time average of electrical current flowing through one of the reactors during execution of the first control task has dropped below a lower threshold value during execution of the first control task, the determiner determines that the current mode is required to change from the continuous current mode to the discontinuous current mode, and wherein
when it is determined that a time average of electrical current flowing through one of the reactors during execution of the second control task has exceeded an upper threshold value that is set greater than the lower threshold value, the switching controller changes the second control task to the first control task in which the current mode is switched to the continuous current mode.

20. The control apparatus as set forth in claim 16, wherein the time average of electrical current flowing through one of the reactors is a smallest one of time averages of electrical currents flowing through the reactors and command values used to create the time averages of electrical currents flowing through the reactors.

21. The control apparatus as set forth in claim 13, wherein each of the reactors has a first end connecting with an input unit,
each of the switching devices connects with a second end of a corresponding one of the reactors,
the DC-to-DC converter includes rectifiers provided one for each of the reactors, each of the rectifiers connecting between an output unit and the second end of a corresponding one of the reactors,
each of the rectifiers works to allow electrical current to flow from a corresponding one of the reactors to the output unit and block a flow of electrical current from the output unit to the one of the reactors.

22. The control apparatus as set forth in claim 21, wherein each of the switching devices is made of a semiconductor switching device equipped with a body diode.

23. The control apparatus as set forth in claim 21, wherein the DC-to-DC converter includes the N reactors where N is an integer more than or equal to two,
the first control task is to control on-off operations of the switching devices to place each of the switching devices in an on-state and then in an off-state each of which appears one time in a specified cycle, times when the switching devices are placed in the on-state being shifted by the specified cycle/N from each other, times when the switching devices are placed in the off-state being shifted by the specified cycle/N from each other,
the second control task is to control the on-off operations of the switching devices to place each of the switching devices in the on-state and then in the off-state each of which appears one time in the specified cycle and to have both the all-on period and the all-off period.

24. A program for used with a DC-to-DC converter which includes a plurality of reactors, switching devices provided one for each of the reactors, and a computer, the reactors being magnetically coupled with each other, each of the switching devices being connected to an end of a corresponding one of the reactors, the program being executed by the computer to perform a switching operation on the switching devices in a selected one of a first control task and a second control task,
the first control task is to control on-off operations of the switching devices not to have at least one of an all-on period and an all-off period, the all-on period being a period of time in which all the switching devices are turned on, the all-off period being a period of time in which all the switching devices are turned off,
the second control task is to control the on-off operations of the switching devices to have both the all-on period and the all-off period,
the switching operation is to change the first control task to the second control task before a current mode is switched from a continuous current mode to a discontinuous current mode.
